(19) United States
(12) Patent Application Publication
(10) Pub. No.: US 2023/0206228 A1
(43) Pub. Date: Jun. 29, 2023

(54) DIGITAL ASSET TRANSFER ACROSS DISTRIBUTED LEDGER NETWORKS

(71) Applicant: Recur Forever Inc., Madison Heights, MI (US)

(72) Inventors: James Seibel, Boston, MA (US); Wayne Edward Nilsen, Amherst, NH (US)

(21) Appl. No.: 17/949,760

(22) Filed: Sep. 21, 2022

Related U.S. Application Data
(60) Provisional application No. 63/293,865, filed on Dec. 27, 2021.

(51) Int. Cl. G06Q 20/38; G06Q 20/36

(52) U.S. Cl. CPC G06Q 20/389; G06Q 20/367

(57) ABSTRACT

A method includes obtaining, from a node of a source distributed ledger network maintaining a source ledger, a first notification of an inter-network transfer process with respect to a digital asset that is associated with a source digital wallet of the source distributed ledger network, causing the digital asset to be associated with a target digital wallet of a target distributed ledger network maintaining a target ledger, obtaining, from the node of the target distributed ledger network, a second notification of the digital asset being associated with the target digital wallet, and in response to obtaining the second notification, finalizing the transfer process. Finalizing the transfer process includes designating the target distributed ledger network as a distributed ledger network maintaining the digital asset.

### RELATED APPLICATION

This application claims the benefit of U.S. Provisional Application No. 63/293,865, filed Dec. 27, 2021 and entitled “Non-Fungible Token Swaps across Distributed Ledgers,” the entire contents of which are hereby incorporated by reference herein.

### TECHNICAL FIELD

The disclosure is generally related to distributed ledgers, and more particularly, to digital asset transfer across distributed ledger networks.

### BACKGROUND

A distributed ledger (“ledger”) is a data structure that maintains electronic transactions (“transactions”) occurring within a distributed ledger network. A transaction generally reflects an update to data maintained by one or more accounts of the distributed ledger. One example of a transaction is a transfer of a digital asset from one entity to another. Another example of a transaction is an exchange of digital assets between entities. An exchange can involve two or more transfers between at least two entities, where each transfer is performed in a respective direction between a pair of entities. For example, an exchange between a first entity and a second entity can include a transfer of a number of units of a first digital asset from the first entity to the second entity, and a transfer of a number of units of a second digital asset from the second entity to the first entity. Yet another example of a transaction is publishing of data (e.g., sharing of medical data, object tracking, vote tracking).

### BRIEF DESCRIPTION OF THE DRAWINGS

The disclosure is illustrated by way of examples, and not by way of limitation, and may be more fully understood with references to the following detailed description when considered in connection with the figures, in which:

FIG. 1 is a block diagram of an example computer system for implementing digital asset transfer management across distributed ledger networks, in accordance with some implementations.

FIG. 2A is a block diagram of an example computer system illustrating a withdrawal process across distributed ledger networks, in accordance with some implementations.

FIG. 2B is a block diagram of an example computer system illustrating a deposit process across distributed ledger networks, in accordance with some implementations.

FIG. 2C is a block diagram of an example computer system illustrating a swap process across distributed ledger networks, in accordance with some implementations.

FIG. 3 depicts a flow diagram of an example method for implementing digital asset management across distributed ledger networks, in accordance with some implementations.

FIG. 4 depicts a block diagram of an illustrative computing device operating in accordance with the examples of the disclosure.

### DETAILED DESCRIPTION

Described herein are systems and methods to implement digital asset transfer management across distributed ledger networks. A ledger of a distributed ledger network can be stored as a chain of cryptographically linked blocks of data (e.g., blockchain), where each block of the ledger maintains a record of one or more completed transactions. More specifically, a block can include one or more transaction records and a cryptographic digest (“digest”) of the previous block representing the previous batch of transactions. A digest can be generated by a one-way function that produces the same output data for a given input. A one-way function is a function that, from a computational complexity perspective, is “easy” to obtain an output for a given input, but “hard” to invert the output to identify the given input. For example, the digest can be a hash value, which is an output string of data generated by employing a hashing method to an input string of data. Although the input string can be arbitrarily large, the output hash value can be set to a fixed size in accordance with the hashing method used. Digests provide a secure way to maintain integrity of the ledger. For example, any attempted change of an earlier block will result in the modified digest of the block, which would require modifications to all subsequent blocks in the blockchain (i.e., tamper-proofing).

The distributed ledger network can include a decentralized network of nodes (i.e., computing devices), each of which maintains a copy of the ledger for tracking and managing transactions. The nodes are responsible for managing (e.g., verifying) the transactions before appending them to the ledger. In other words, the network of nodes does not employ a centralized intermediary (e.g., exchange) for managing transactions. A consensus protocol is a decentralized process employed by the nodes for verifying a transaction before a corresponding block can be added to the ledger. For example, verifying the transaction can include determining whether a source account has enough balance to transfer the amount specified by the transaction. The consensus protocol can manage transaction verification by determining which node(s) are able to verify the transaction. For example, nodes can compete against each other to be the first to verify the transaction (e.g., “Proof of Work” consensus protocol). As another example, a single node can be selected to perform block validation (e.g., “Proof of Stake” consensus protocol).

A ledger can maintain transactions related to a digital asset within a distributed ledger network. A digital asset refers to electronic property that is owned by an entity (e.g., a person) and has a distinct usage right. Not all distributed ledger networks may support a particular type of digital asset. As such, in some cases, an entity wishing to exchange one digital asset of a source distributed ledger network for another digital asset that is not supported by the source distributed ledger network may need to make one or more digital asset conversions using intermediate digital assets to accomplish the exchange. There is also an associated counterparty risk if the entity wishes to exchange digital assets with another entity.

A smart contract is a sequence of executable instructions stored on a ledger within a distributed ledger network. The executable instructions specify one or more conditions to be verified and one or more actions to be performed should the conditions be successfully validated. For example, a smart contract can control the transfer of a digital asset between parties (e.g., digital wallets) specified by the smart contract.

A digital asset can be represented by a cryptographic token (“token”). One example of a token is a fungible token, in which the digital asset represented by the fungible token is replaceable with something of equal value. For example, a fungible token can represent a unit of value of a cryptocurrency (e.g., digital coin). Another example of a token is a non-fungible token (NFT). In contrast to fungible tokens, an NFT is a unique token that is not replaceable with something of equal value (i.e., not mutually interchangeable with other objects of the same category).

A digital asset wallet (“digital wallet”) is an electronic account controlled (e.g., owned) by an entity that enables the entity to perform transactions, such as send, retrieve and/or store digital assets outside of a digital asset exchange platform. A digital wallet stores, for each digital asset, information regarding the location of the digital asset on the corresponding ledger. A digital wallet can be identified by the public key of a key pair. The public key defines an address for the digital wallet that others can use to send digital assets to the digital wallet. The private key of the key pair is used to digitally sign transactions. For example, when a transaction is initiated, the digital wallet software can create a digital signature by processing the transaction with the private key. Another entity can verify the digital signature to determine that a transaction was initiated from the digital wallet.

For example, a digital wallet can be implemented using a hardware wallet. A hardware wallet is a special purpose computing device that executes software to support offline digital asset storage (i.e., cold storage). Access to digital assets via the hardware wallet is enabled via a private key after the external physical device is connected to a main computing device. As another example, a digital wallet can be implemented using a software wallet. A software wallet is an application running on a general purpose computing device (e.g., desktop, laptop or mobile device) that enables access to digital assets that are stored on a remote server (e.g., cloud server).

An account owner can obtain a digital asset (e.g., NFT), thus becoming an owner of the digital asset. The digital asset owner can have access to at least one digital wallet, where each digital wallet can store digital assets of a respective distributed ledger network. As another example, the account owner can obtain the digital asset from an entity that is not the digital asset issuer, such as the previous owner or other intermediary. For example, the account owner can be a digital asset issuer that creates (i.e., generates) the digital asset, or can receive the digital asset after its creation. In some cases, the digital asset issuer is a digital asset marketplace (e.g., NFT marketplace), which is an online platform that enables individuals to buy, sell and/or trade digital assets.

The digital asset issuer can create a digital asset by transforming an underlying asset, or a data representation of the underlying asset, into the digital asset. For example, the underlying asset can be a physical asset (e.g., real estate, physical artwork, a gemstone, memorabilia), a digital asset, such as a digital file (e.g., digital image, audio file, video game asset), etc. For example, the data representation can be a digital file, such as an image file, video file, audio file, audiovisual file, etc. Creating the digital asset can include tokenizing the underlying asset or a data representation of the underlying asset (e.g., to obtain an NFT). Thus, the digital asset can be used to prove and verify that the underlying asset belongs to a particular entity. It is possible to generate multiple NFTs that each are linked to a respective copy of an underlying asset.

To create the digital asset, the digital asset issuer can further specify a set of parameters, such as name, description, distributed ledger network, etc. After specifying the data representation and the set of parameters, the digital asset issuer can proceed to create the digital asset by executing a set of executable instructions (e.g., a set of executable instructions of a smart contract). The set of executable instructions can include an instruction that, when executed, can determine whether there are sufficient funds in the digital wallet owned by the digital asset issuer to handle the transaction costs. The set of executable instructions can further include an instruction that, when executed after determining that there are sufficient funds in the digital wallet, can generate the digital asset from a set of inputs. More specifically, the digital asset can be generated as a digest from a set of inputs including an identifier of the digital asset (e.g., index of the digital asset), an address of the digital wallet, and a timestamp of the transaction. For example, the identifier of the digital asset can be an unsigned integer having a suitable size. In some cases, the unsigned integer is a 256-bit integer (“unit256”). The set of executable instructions can further include an instruction that, when executed, can send the digital asset to the digital wallet specified by the address. For example, the digital wallet can be a digital wallet managed by the digital asset issuer. Such a digital wallet can be referred to as a private wallet. As another example, the digital wallet can be a digital wallet managed by a custodian (i.e., custodian wallet). With a custodian wallet, the private key stays with the custodian. The custodian can assist with account retrieval and facilitating transactions.

Minting is the process of adding a digital asset to a digital ledger (i.e., recording the digital asset on the digital ledger). The digital asset can be added to the digital ledger using the underlying asset, or a reference to the underlying asset. For example, the reference to the underlying asset can be a reference address, such as a universal resource identifier (URI) (e.g., a universal resource locator (URL)). Like any other transaction, a consensus protocol can be used by the nodes of the distributed ledger network to verify the mint transaction before it can be added to the ledger.

Since a distributed ledger network is immutable, the digital asset cannot be deleted from existence within the distributed ledger network. Instead, a “burn” operation can be performed to remove the digital asset from circulation within a distributed ledger network. Burning can include transferring the digital asset from the address of the source digital wallet to a special purpose digital wallet (e.g., the null address), from which the digital asset cannot be transferred by future transactions. Thus, although a burned digital asset still exists within the distributed ledger network, the burned digital asset is inaccessible to wallets within the distributed ledger network. Burning a digital asset can involve payment of transaction fees. For example, after receiving a request to burn a digital asset, a digital asset issuer can proceed to burn the digital asset by executing a set of executable instructions (e.g., a set of executable instructions of a smart contract). The set of executable instructions can include an instruction that, when executed, can determine whether there are sufficient funds in the digital wallet connected to the digital asset issuer. The set of executable instructions can further include an instruction that, when executed after determining that there are sufficient funds in the digital wallet, can transfer the digital asset to the special purpose digital wallet.

A distributed ledger network can be isolated from other distributed ledger networks. Thus, the distributed ledger network may be unable to facilitate communications between its entities and entities of other distributed ledger networks. Accordingly, a distributed ledger network may not be able to support a transfer of a digital asset (e.g., NFT) from one distributed ledger network to a different distributed ledger network.

Aspects of the disclosure address the above and other deficiencies by providing technology that facilitates digital asset transfer across distributed ledger networks. For example, the digital asset can be an NFT. The digital asset can be owned by a digital asset owner and can be issued (i.e., created) by a digital asset issuer. In some cases, the digital asset issuer is the digital asset owner. In some cases, another entity is the digital asset owner (e.g., the digital asset issuer transferred ownership of the digital asset to the other entity). In some cases, an authorized digital asset custodian can have control over the digital asset.

For example, a digital asset management system (DAMS) can facilitate an inter-network transfer process to transfer a digital asset from a source digital wallet supported by a source distributed ledger network to a target digital wallet supported by a target distributed ledger network different from the source distributed ledger network. For example, the digital asset owner can link a digital wallet to fund the inter-network transfer processes. The inter-network transfer process can be supported and controlled by executable instructions (e.g., smart contracts). For example, one set of executable instructions (e.g., one smart contract) can be stored on the source ledger, and another set of executable instructions (e.g., another smart contract) can be stored on the target ledger. A subset of the set of executable instructions stored on the source ledger can be used to burn a digital asset with respect to the source distributed ledger network, and a subset of the set of executable instructions stored on the target ledger can be used to mint the digital asset with respect to the target distributed ledger network. In some implementations, each set of executable instructions includes the same instructions. In some implementations, the DAMS creates each set of executable instructions and causes each set of executable instructions to be stored on a respective ledger. In some implementations, the digital asset issuer creates each set of executable instructions and causes each set of executable instructions to be stored on a respective ledger.

To illustrate an inter-network transfer process, a transfer initiation entity can initiate an inter-network transfer of a digital asset (e.g., NFT) from a source digital wallet to a target digital wallet. The transfer initiation entity can be the digital asset owner, or a proxy for the digital asset owner (e.g., the DAMS or a third-party custodian). Initiating the inter-network transfer of the digital asset can include causing the source digital wallet to broadcast an inter-network transfer transaction to the nodes of the source distributed ledger network. Initiating the inter-network transfer of the digital asset can include selecting the type of inter-network transfer process supported by the executable instructions (e.g., smart contract).

A node of the source distributed ledger network, upon observing the transfer transaction, can cause the digital asset to be removed from the source digital wallet (“burned”). For example, burning the digital asset can include transferring the digital asset from the source digital wallet to a special purpose digital wallet within the source distributed ledger network (e.g., the null address). More specifically, the node of the source distributed ledger network can cause the execution of a burn function defined by one or more executable instructions of the set of executable instructions stored on the source ledger for controlling the inter-network transfer process (e.g., smart contract). The burn function, when executed, can cause the digital asset to be sent to the special purpose digital wallet.

After removing the digital asset from the source digital wallet, the node of the source distributed ledger network can emit an inter-network transfer event notification. The transfer event notification can include relevant information that can be used to identify the transfer. For example, the transfer event notification can include the digital asset identifier, the address of the source digital wallet, the address of the target digital wallet, etc.

The DAMS can continuously listen for event notifications generated by nodes of respective distributed ledger networks, such as inter-network transfer event notifications. The inter-network transfer event notification indicates that the digital asset was successfully removed from the source digital wallet (i.e., burned) as part of the transfer process, and is therefore eligible to be minted onto the target ledger and added to the target digital wallet. Thus, upon observing the inter-network transfer event notification emitted by the node of the source distributed ledger network, the DAMS can broadcast a mint transaction to the nodes of the target distributed ledger network corresponding to the target digital wallet.

A node of the target distributed ledger network, upon observing the mint transaction, can cause the digital asset to be minted onto the target ledger. More specifically, the node of the target distributed ledger network can cause the execution of a mint function defined by one or more executable instructions of the set of executable instructions stored on the target ledger for controlling the inter-network transfer process (e.g., smart contract). The mint function, when executed, can cause the digital asset to be added to the target ledger and the target digital wallet.

After the digital asset is added to the target ledger and the target digital wallet, the node of the target distributed ledger network can emit a success event notification indicating the completion of the mint function. The DAMS can observe the success event notification and, in response, can finalize the transfer process. Finalizing the transfer process can involve designating the target distributed ledger network as the distributed ledger network that includes the digital asset. For example, the DAMS can update a digital asset data structure to indicate that the digital asset has been added to the target ledger and/or is stored in the target digital wallet. The digital asset data structure can maintain, for each digital asset tracked by the DAMS, digital asset metadata, including metadata indicating a location of the digital asset (e.g., ledger and/or wallet).

If a distributed ledger network (e.g., the source distributed ledger network or the target distributed ledger network) does not utilize a protocol supporting smart contracts, then the protocol of the distributed ledger network has to provide support to implement the functionality of the inter-network transfer process described herein (e.g., burn function, mint function) without needing a custom smart contract. If a distributed ledger network does not utilize a protocol supporting the functionality of the inter-network transfer process described herein, then the distributed ledger network is a non-supported distributed ledger network. Accordingly, a non- supported distributed ledger network cannot be a source distributed ledger network or a target distributed ledger network for the inter-network transfer process.

The DAMS can manage digital assets on behalf of digital asset owners (i.e., users of the DAMS). For example, the DAMS can custody digital assets for digital asset owners using a custodied digital wallet under control of the DAMS. In some implementations, the digital asset owner can create a user account for the DAMS (e.g., via a website associated with the DAMS).

Depending on the purpose of the inter-network transfer, the transfer initiating entity can select a type of inter-network transfer process supported by the executable instructions (e.g., smart contract). Multiple types of inter-network transfer processes may be supported by the executable instructions (e.g., smart contract). Examples of inter-network transfer process types include a withdrawal process, a deposit process, and a pseudo-anonymous swap process.

The withdrawal process can be used by a digital asset owner, as a user of the DAMS, to withdraw a digital asset that is currently in custody of the DAMS. That is, the source digital wallet can be a digital wallet under control of the DAMS (i.e., custodied wallet). The target digital wallet can be a digital wallet under control of the digital asset owner (i.e., private wallet), or another digital wallet under control of another entity (i.e., another custodied wallet). Upon receiving a command to initiate the withdrawal process and determining that the withdrawal process can be initiated (e.g., determining that the digital asset owner has sufficient funds to perform the withdrawal process), the DAMS can cause the inter-network transfer process to be performed by removing the digital asset from the digital wallet under control of the user (i.e., the private wallet), and adding the digital asset to the target ledger and the digital wallet under control of the DAMS (i.e., the custodied wallet).

Conversely, the deposit process can be used by a digital asset owner to deposit a digital asset into the digital wallet under control of the DAMS (i.e., to provide custody of the digital asset to the DAMS). That is, the source digital wallet is a digital wallet under control of the digital asset owner (i.e., private wallet), and the target digital wallet is a digital wallet under control of the DAMS (i.e., custodied wallet). Upon receiving a command to initiate the deposit process and determining that the deposit process can be initiated (e.g., that the digital asset owner has sufficient funds to perform the deposit process), the DAMS can cause the digital asset to be removed from the source digital wallet (i.e., the digital wallet under control of the user), and added to the target ledger and the target digital wallet (i.e., the digital wallet under control of the DAMS). The DAMS can associate the digital asset owner with an identifier linking the digital asset owner to the digital asset. The DAMS can use the identifier to credit the digital asset owner with ownership of the digital asset while the digital asset is under custody of the DAMS. The digital asset owner (or other entity) can withdraw the digital asset from the digital wallet under control of the DAMS using the withdrawal process described above, or swap the digital asset with another digital asset owner using the pseudo-anonymous swap process described below.

The pseudo-anonymous swap process can be used to enable digital asset owners to perform an inter-network swap of their digital assets. For example, the digital assets can include a first digital asset owned by a first digital asset owner and a second digital asset owned by a second digital asset owner. That is, the source digital wallet is a digital wallet under control of the first digital asset owner as a user of the DAMS, or a digital wallet under control of the DAMS. The target digital wallet can be a digital wallet under control of the second digital asset owner (who may or may not be a user of the DAMS). Upon receiving a command to initiate the pseudo-anonymous swap process and determining that the pseudo-anonymous swap process can be initiated (e.g., determining that at least the first digital asset owner has sufficient funds to perform the withdrawal process), the DAMS can cause the inter-network transfer process to be performed by removing the first digital asset from the digital wallet under control of the first digital asset owner, and adding the first digital asset to the target ledger and the digital wallet under control of the second digital asset owner. Moreover, the DAMS can facilitate the removal of the second digital asset from the digital wallet under control of the second digital asset owner, and the addition of the second digital asset to the digital wallet under control of the first digital asset owner (or the digital wallet under control of the DAMS).

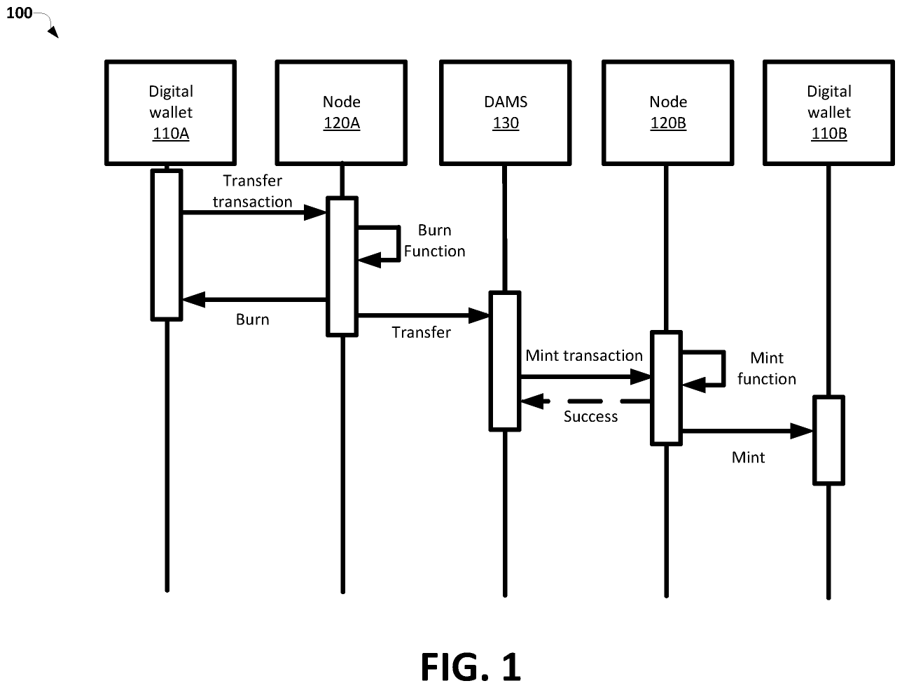

Aspects and implementations described herein include technology that can provide a number of technical advantages. For example, implementations described herein can enhance efficiency and/or performance of a computing system by improving efficiency of computing resources, such as processor, memory and bandwidth resource consumption (e.g., reducing processor, memory and bandwidth resource usage). Additionally, by enabling digital assets to be transferred between digital wallets of different distributed ledger networks, implementations described herein can maximize the utility of digital assets by enabling applications on every supported ledger to use the digital asset, increase digital asset market liquidity, and digital asset utility (e.g., NFTs in online gaming). Moreover, implementations described herein can enable the transfer of digital assets to more advanced and/or popular distributed ledger networks without having to worry about future digital asset protocols, which can maintain or improve the relevancy of the digital asset over time. Various aspects of the above referenced methods and systems are described in further detail herein below by way of examples, rather than by way of limitation. Further details regarding implementing digital asset transfer management across distributed ledger networks will now be described in further detail below with reference to FIGS. 1-4.

FIG. 1 is a diagram of an example computer system (“system”) 100 for implementing digital asset transfer management across distributed ledger networks, in accordance with some implementations. As shown, the system 100 includes a digital wallet 110A for storing digital assets of a source distributed ledger network, a digital asset entity 110B for storing digital assets of a target distributed ledger network different from the source distributed ledger network, at least one node 120A of the source distributed ledger network, at least one node 120B of the target distributed ledger network, and a digital asset management system (DAMS) 130. The nodes 120A and 120B can each maintain local instances of a respective ledger of its respective distributed ledger network. The DAMS 130 can be a hardware and/or software component. For example, the DAMS 130 can operate on a server.

In this example, it is assumed that a digital asset (e.g., NFT) is currently stored in the digital wallet 110A, also referred to as the source digital wallet. However, the owner of the digital wallet 110A would like to transfer the digital asset from the digital wallet 110A to the digital wallet 110B, also referred to as the target digital wallet. The owner of the digital wallet 110A can also be the owner of the digital wallet 110B. Alternatively, the owner of the digital wallet 110A can be different from the owner of the digital wallet 110B. For example, the owner of the digital wallet 110A and/or the owner of the digital wallet 110B can be a user (e.g., the digital asset owner). As another example, the owner of the digital wallet 110A and/or the digital wallet 110B can be the DAMS 130. As yet another example, the owner of the digital wallet 110A and/or the digital wallet 110B can be a third-party entity that serves as a proxy for the user and/or the DAMS (e.g., custodian).

To transfer the digital asset, the owner of the digital wallet 110A can initiate an inter-network transfer process to transfer the digital asset from the digital wallet 110A to the digital wallet 110B. For example, the owner of the digital wallet 110A can cause the digital wallet 110A to broadcast an inter-network transfer transaction to the nodes of the source distributed ledger network (“Transfer transaction”). It is assumed that the node 120A observes the inter-network transfer transaction.

Upon observing the inter-network transfer transaction, the node 120A can cause the digital asset to be burned to remove the digital asset from circulation with respect to the source distributed ledger network. For example, burning the digital asset can include transferring the digital asset from the digital wallet 110A to a special purpose digital wallet within the source distributed ledger network (e.g., the null address). More specifically, the node 120A can cause the execution of a burn function. The burn function, when executed, can cause the digital wallet 110A to burn the digital asset by sending the digital asset to the special-purpose digital wallet. The burn function can be defined by one or more instructions of a set of executable instructions stored on the source ledger for controlling the inter-network transfer process. In some implementations, the set of executable instructions stored on the source ledger is included within a smart contract stored on the source ledger for controlling the inter-network transfer process.

The set of executable instructions (e.g., smart contract) stored on the source ledger can be a custom set of executable instructions for implementing the inter-network transfer process. For example, the set of executable instructions stored on the source ledger can be created by the digital asset issuer. As another example, the set of executable instructions stored on the source ledger can be created by the DAMS 130. It is assumed that the source distributed ledger network is a supported distributed ledger network that utilizes a protocol supporting the use of the set of executable instructions (e.g., smart contract).

After burning the digital asset and thus removing it from the digital wallet 110A, the node 120A can emit an inter-network transfer event notification (“Transfer”). The inter-transfer event notification indicates that the digital asset was burned within the source distributed ledger network as a result of the transfer process.

The DAMS 130 can continuously listen for event notifications generated by nodes of respective distributed ledger networks, such as inter-network transfer event notifications. The DAMS 130 can observe the transfer event notification. After observing the transfer event notification emitted by the node 120A, the DAMS 130 can broadcast a mint transaction to nodes of the target distributed ledger network (“Mint transaction”). It is assumed that the node 120B observes the mint transaction.

When the node 120B observes the mint transaction, the node 120B can cause the digital asset to be minted. For example, minting the digital asset can include adding the digital asset to the target ledger and the digital wallet 110B. More specifically, the node 120B can cause the digital asset to be minted (e.g., added to the target ledger and the digital wallet 120B) (“Mint”). The mint function can be defined by one or more instructions of a set of executable instructions stored on the target ledger for controlling the inter-network transfer process. In some implementations, the set of executable instructions stored on the target ledger is included within a smart contract stored on the target ledger for controlling the inter-network transfer process.

Similar to the set of executable instructions stored on the source ledger, the set of executable instructions stored on the target ledger (e.g., smart contract) can be a custom set of executable instructions for implementing the inter-network transfer process. For example, the set of executable instructions stored on the target ledger can be created by the digital asset issuer. As another example, the set of executable instructions stored on the target ledger can be created by the DAMS 130. It is assumed that the target distributed ledger network is a supported distributed ledger network that utilizes a protocol supporting the use of the set of executable instructions (e.g., smart contract).

After the digital asset is added to the digital wallet 110B, the node 120B can emit a success event notification (“Success”) indicating the completion of the mint function. The DAMS 130 can observe the success event notification and, in response, can finalize the inter-network transfer process. Finalizing the inter-network transfer process can include identifying the target distributed ledger network as the distributed ledger network that has the digital asset, thus completing the transfer process to the target distributed ledger network. For example, the DAMS 130 can update a digital asset data structure to indicate that the digital asset is stored in the digital wallet 110B. It is assumed that the source distributed ledger network and the target distributed ledger network each utilize a respective protocol that supports the implementation of the functionality of the inter-network transfer process (e.g., burn function, mint function).

The DAMS 130 can maintain at least one private key that controls execution of the sets of instructions (e.g., smart contracts) for implementing the inter-network transfer process. For example, the DAMS 130 can use at least one private key to sign and submit transactions during the transfer process. What distinguishes an operator of the DAMS 130 “DAMS operator”) from another entity is the possession of the private key. This is similar to how the owner of the digital asset is distinguished from the non-owner of the digital asset. For example, the mint process, which is controlled by the DAMS 130 as described above, is limited to the operator of the DAMS 130. The DAMS operator can be a special trusted entity (“privileged”) that has ultimate control over the withdrawal process. However, the DAMS operator can choose to authorize one or more proxies (e.g., one or more custodians) to execute certain operations on behalf of the DAMS operator (i.e., manage the withdrawal process on behalf of the DAMS operator). More specifically, the DAMS operator can add and/or remove proxies to operate the DAMS 130 on behalf of the DAMS operator. Each proxy can be listed as an additional DAMS operator (e.g., via the smart contract). In some implementations, a proxy is the digital asset owner. In some implementations, a proxy is a third-party entity (i.e., a custodian that is neither the digital asset owner nor the DAMS 130).

Multiple types of inter-network transfer processes may be supported by the system 100. Initiating the inter-network transfer process can include selecting the type of inter-network transfer process. The type of inter-network transfer process is supported by the set of executable instructions stored on the source distributed ledger network, and the set of executable instructions stored on the target distributed ledger network.

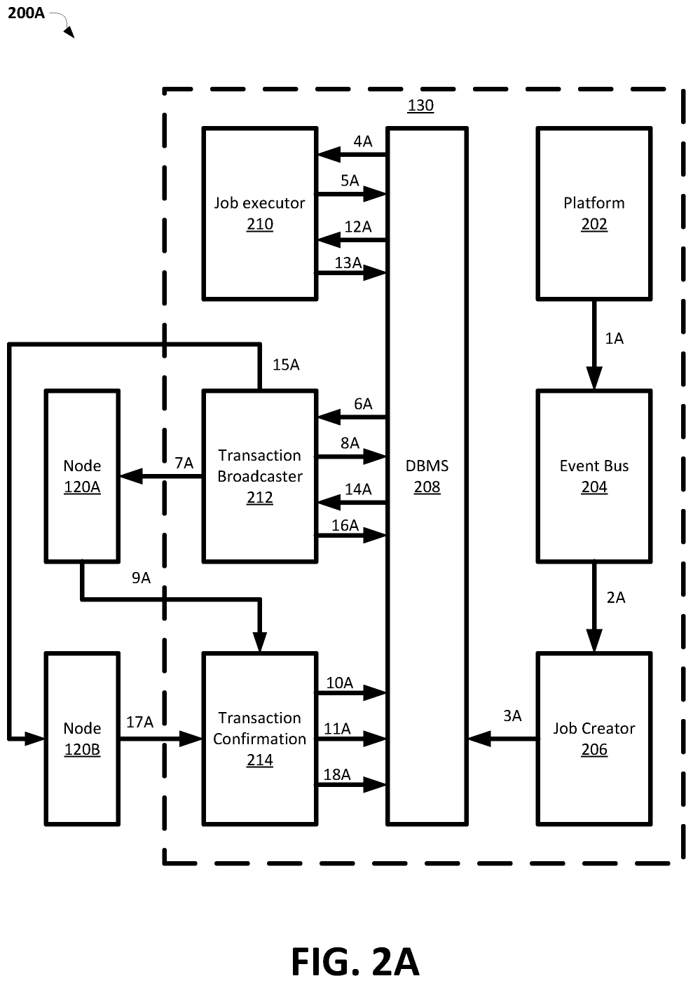

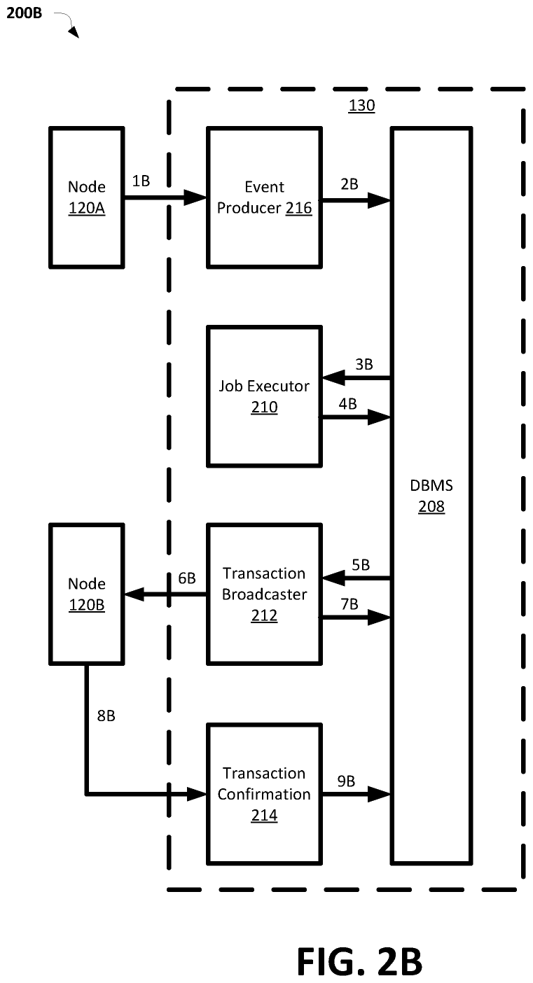

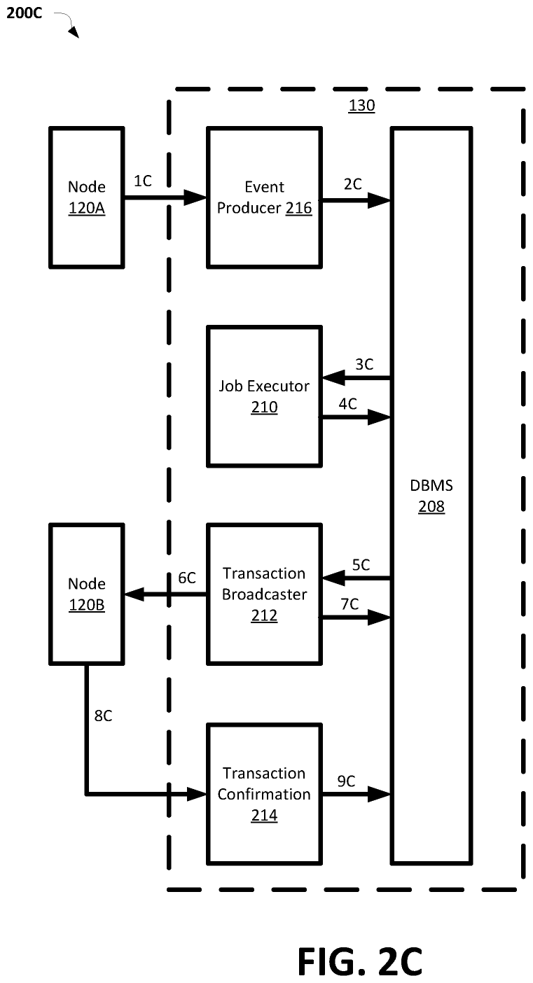

In some implementations, the digital wallet 110A is a digital wallet under control of the DAMS 130 (i.e., a custodied wallet), and the digital wallet 110B is a digital wallet under control of the digital asset owner (i.e., a private wallet) or a digital wallet under control of a third-party proxy (i.e., another custodied wallet). In this case, the digital asset owner, as a user of the DAMS 130, can cause the DAMS 130 to initiate a withdrawal process to withdraw a digital asset from the digital wallet under control of the DAMS 130, and add the digital asset to the digital wallet under control of the digital asset owner or the digital wallet under control of the third-party proxy. More specifically, the digital asset can specify the address of the digital wallet 110B. Further details regarding the withdrawal process will be described below with reference to FIG. 2A.

In some implementations, the digital wallet 110A is a digital wallet under control of the digital asset owner, and the digital wallet 110B is a digital wallet under control of the DAMS 130. In this case, the digital asset owner, as a user of the DAMS 130, can cause the DAMS 130 to initiate a deposit process to deposit a digital asset into the digital wallet under control of the DAMS 130. Further details regarding the deposit process will be described below with reference to FIG. 2B.

In some implementations, the digital wallet 110A is a digital wallet under control of a first digital asset owner or a digital wallet under control of the DAMS 130, and the digital wallet 110B is a digital wallet under control of a second digital asset owner. In this case, the DAMS 130 can facilitate a pseudo-anonymous swap process. More specifically, the pseudo-anonymous swap process can be used to transfer a first digital asset from the digital wallet 110A to the digital wallet 110B, and a second digital asset from the digital wallet 110B to the digital wallet 110A. That is, the DAMS 130 can provide anonymity regarding the parties of a digital asset swap. Further details regarding the swap process will be described below with reference to FIG. 2C.

The DAMS 130 can include a set of execution components (e.g., workers) that receive notifications and broadcast transactions. The set of execution components can include multiple multithreaded, independent components that can enable multicore processing and prevent computational overloading. Each execution component can be a hardware and/or software component. When a new block arrives, the set of execution components can break the block up into its constituent transactions, and each transaction can be scanned by the set of execution components for changes in digital asset ownership. For example, the set of execution components can utilize efficiently stored event indices for faster querying. Any changes in digital asset ownership can be tracked in the data structure for quick lookup. For example, indices can be placed on fields including address, transaction hash, block height, transaction index, and token identifier (ID). The amount of data filtered from a distributed ledger network can be, on average, over 4 orders of magnitude of the data of the distributed ledger network (e.g., about 1/10000 of the data), and highly efficient to be queried for relevant digital asset transactions. Other subsystems that can update in response to digital asset transactions can receive updates to the data structure, including receiving relevant information that reduces bandwidth consumption. Tracking digital assets across all distributed ledger networks supported by a digital asset issuer can be a computationally heavy task. To accomplish this, the DAMS 130 can implement a highly performant and scalable digital asset database management system (DBMS). In some implementations, the DBMS is a relational DBMS (RDBMS). The DBMS can maintain information regarding digital asset transfers, such as jobs and transactions, and the set of execution components can interact with the DBMS to manage the transfer process. Further details regarding the set of execution components and the DBMS will be described in further detail below with reference to FIGS. 2A-2C.

FIG. 2A is a block diagram of an example computer system 200A illustrating a withdrawal process, in accordance with some implementations. The system 200A includes the node 120A, the node 120B and the DAMS 130 of FIG. 1. The withdrawal process can enable an entity to withdraw a digital asset from a source digital wallet of a source distributed ledger network (e.g., the digital wallet 110A of FIG. 1), and transfer the digital asset to a target digital wallet of a target distributed ledger network (e.g., the digital wallet 110B of FIG. 1). For example, the entity can be the digital asset owner. As another example, the entity can be a proxy. More specifically, the source digital wallet can be a custodied digital wallet under control of the DAMS 130, and the target digital wallet can be a digital wallet under control of a user (e.g., customer), or a different custodied digital wallet.

As shown in FIG. 2A, the DAMS 130 can include a platform 202, an event bus 204, a job creator 206, a database management system (DBMS) 208, and a set of execution components including a job executor 210, a transaction broadcaster 212 and a transaction confirmation component 214. In some implementations, the DBMS 208 is a relational DBMS (RDMBS).

At step 1A, the platform 202 can generate a notification of a withdrawal process and send the notification to the event bus 204. At step 2A, the event bus 204 can forward the instruction to the job creator 206. At step 3A, the job creator 206, in response to receiving the instruction, can create a swap job in a pending state, and insert the swap job in the pending state into the DBMS 208.

At step 4A, the job executor 210 can receive the swap job in the pending state from the DBMS 208. At step 5A, the job executor 210 can update the state of the swap job to an in-progress state, create a record of a swap transaction (“swap transaction record”) in a pending state, and insert the swap transaction record in the pending state into the DBMS 208.

At step 6A, the transaction broadcaster 212 can receive the swap transaction record in the pending state from the DBMS 208. At step 7A, the transaction broadcaster 212 can broadcast the swap transaction to the nodes of the source distributed ledger network (e.g., node 120A). At step 8A, the transaction broadcaster 212 can update the state of the swap transaction record to a broadcast state.

At step 9A, the node 120A can observe the swap transaction, burn the digital asset in response to observing the swap transaction (e.g., by executing a respective instruction of a smart contract for controlling the withdrawal process), and can emit a swap notification indicating that the digital asset has been successfully burned and removed from the source digital wallet. At step 10A, the transformation confirmation component 214 can observe the swap notification and can finalize the swap job and the swap transaction in response to observing the swap notification by updating their respective states to a complete state within the DBMS 208.

At step 11A, the transaction confirmation component 214 can create a mint job in a pending state and insert the mint job in the pending state into the DBMS 208. At step 12A, the job executor 210 can receive the mint job in the pending state from the DBMS 208 and execute the mint job. At step 13A, the job executor can update the state of the mint to an in-progress state, create a record of a mint transaction (“mint transaction record”) in a pending state, and insert the mint transaction record in the pending state into the DBMS 208.

At step 14A, the transaction broadcaster 212 can receive the mint transaction record in the pending state from the DBMS 208. At step 15A, the transaction broadcaster 212 can broadcast a mint transaction to the nodes of the target distributed ledger network (e.g., node 120B). At step 16A, the transaction broadcaster 212 can update the state of the mint transaction record to a broadcast state.

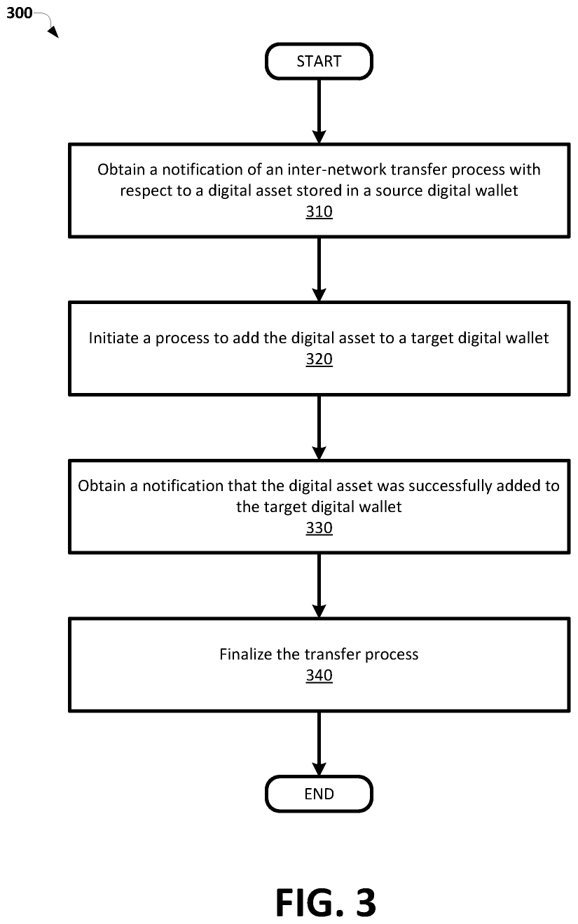

At step 17A, the node 120B can observe the mint transaction, mint the digital asset in response to observing the mint transaction (e.g., by executing a respective instruction of the smart contract), and can emit a mint event indicating that the digital asset has been successfully minted and added to the target digital wallet. At step 18A, the transaction confirmation component 214 can observe the mint event and can finalize the mint job and the mint transaction in response to observing the mint event by updating their respective states to a complete state within the DBMS 208. Further details regarding FIG. 2A are described above with reference to FIG. 1 and will be described below with reference to FIG. 3.

FIG. 2B is a block diagram of an example computer system 200B illustrating a deposit process, in accordance with some implementations. As shown, the system 200B includes the node 120A, the node 120B and the DAMS 130 of FIG. 1. The deposit process can enable a user (e.g., digital asset owner) to deposit a digital asset within a target digital wallet (e.g., digital wallet 110B of FIG. 1) under control of the user. More specifically, the digital asset can be maintained in a source digital wallet custodied by a third-party (e.g., digital wallet 110A of FIG. 1). The user can select which distributed ledger network to transfer the digital asset.

As shown in FIG. 2B, the DAMS 130 can include the DBMS 208, and a set of execution components including the job executor 210, the transaction broadcaster 212 and the transaction confirmation component 214 as described above with reference to FIG. 2A. In this illustrative example, the DAMS 130 can further include an event producer 216.

At step 1B, the node 120A can burn a digital asset (e.g., by executing a respective instruction of on a smart contract for controlling the deposit process) and can emit a deposit event indicating that the digital asset was burned during the deposit process. At step 2B, the event producer 216 can observe the deposit event, create a mint job in a pending state for the deposit process in response to observing the deposit event, and insert the mint job in the pending state into the DBMS 208.

At step 3B, the job executor 210 can receive the mint job in the pending state from the DBMS 208 and execute the mint job. At step 4B, the job executor can update the state of the mint job to an in-progress state, create a record of a mint transaction (“mint transaction record”) in a pending state, and insert the mint transaction record in the pending state into the DBMS 208.

At step 5B, the transaction broadcaster 212 can receive the mint transaction record in the pending state from the DBMS 208. At step 6B, the transaction broadcaster 212 can broadcast a mint transaction to the nodes of the target distributed ledger network (e.g., node 120B). At step 7B, the transaction broadcaster 212 can update the state of the mint transaction record to a broadcast state.

At step 8B, the node 120B can observe the mint transaction, mint the digital asset in response to observing the mint transaction (e.g., by executing a respective instruction of the smart contract), and can emit a mint event indicating that the digital asset has been successfully minted and added to the target digital wallet. At step 9B, the transaction confirmation component 214 can observe the mint event and can finalize the mint job and the mint transaction in response to observing the mint event by updating their respective states to a complete state. Further details regarding FIG. 2B are described above with reference to FIG. 1 and will be described below with reference to FIG. 3.

FIG. 2C is a block diagram of an example computer system 200C illustrating a swap process, in accordance with some implementations. As shown, the system 200C includes the node 120A, the node 120B and the DAMS 130 of FIG. 1. The swap process can enable an entity to swap a digital asset (e.g., NFT). More specifically, the swap process can be used to transfer the digital asset from a source digital wallet (e.g., the digital wallet 110A of FIG. 1) to a target digital wallet (e.g., the digital wallet 110B of FIG. 1). For example, the swap process can be a pseudo-anonymous swap process.

As shown in FIG. 2C, the DAMS 130 can include the DBMS 208, and a set of execution components including the job executor 210, the transaction broadcaster 212 and the transaction confirmation component 214, and the event producer 216, as described above with reference to FIGS. 2A-2B.

At step 1C, the node 120A can burn a digital asset (e.g., by executing a respective instruction of a smart contract for controlling the swap process) and can emit a swap event indicating that the digital asset was burned during the swap process. At step 2C, the event producer 216 can observe the swap event, create a mint job in a pending state for the swap process in response to observing the swap event, and insert the mint job in the pending state into the DBMS 208.

At step 3C, the job executor 210 can receive the mint job in the pending state from the DBMS 208 and execute the mint job. At step 4C, the job executor can update the state of the mint job to an in-progress state, create a record of a mint transaction (“mint transaction record”) in a pending state, and insert the mint transaction record in the pending state into the DBMS 208.

At step 5C, the transaction broadcaster 212 can receive the mint transaction record in the pending state from the DBMS 208. At step 6C, the transaction broadcaster 212 can broadcast a mint transaction to the node 120B. At step 7C, the transaction broadcaster 212 can update the state of the mint transaction record to a broadcast state.

At step 8C, the node 120B can observe the mint transaction, mint the digital asset in response to observing the mint transaction (e.g., by executing a respective instruction on the smart contract), and can emit a mint event indicating that the digital asset has been successfully minted and added to the target digital wallet. At step 9C, the transaction confirmation component 214 can observe the mint event and can finalize the mint job and the mint transaction in response to observing the mint event by updating their respective states to a complete state. Further details regarding FIG. 2C are described above with reference to FIG. 1 and will be described below with reference to FIG. 3.

FIG. 3 depicts a flow diagram of an example method 300 for implementing digital asset management across distributed ledger networks, in accordance with some implementations. For example, the method 300 may be performed by DAMS 130 as shown in FIGS. 1-2C. Method 300 may be performed by one or more processing devices that may comprise hardware (e.g., circuitry, dedicated logic, programmable logic, microcode, etc.), executable code (such as is run on a general-purpose computer system or a dedicated machine), or a combination of both. For example, the one or more processing devices can perform individual functions, routines, subroutines, or operations to implement the method 300.

At block 310, processing logic obtains a notification of an inter-network transfer process with respect to a digital asset stored in a source digital wallet. The source digital wallet is a digital wallet of a source distributed ledger network. The source distributed ledger network includes a set of nodes managing transactions with respect to a source ledger. The notification can be received after the digital asset has been burned from the source digital wallet, such as by being sent to a digital wallet located at a special purpose address (e.g., the null address). For example, the notification of the inter-network transfer process can be an inter-network transfer event notification, and obtaining the notification of the inter-network transfer process can include observing the inter-network transfer event notification.

More specifically, the inter-network transfer process can be initiated by causing the source digital wallet to send an inter-network transfer transaction to a node of the source distributed ledger network, an inter-network transfer transaction via the source digital wallet. In response to receiving the inter-network transfer transaction from the source digital wallet, the node of the source distributed ledger network can cause the digital asset to be burned from the source digital wallet. For example, the node of the source distributed ledger network can execute a subset of executable instructions of a set of executable instructions stored on the source ledger. In some implementations, the set of executable instructions stored on the source ledger is comprised with a smart contract for controlling the inter-network transfer process. The node of the source distributed ledger network can then emit the inter-network transfer event notification in response to determining that the digital asset has been successfully burned from the source digital wallet. For example, the node of the source distributed ledger network can emit the inter-network transfer event notification in response to verifying that the digital asset was burned and updating the source ledger to reflect that the digital asset was burned.

In some implementations, initiating the inter-network transfer process includes processing logic (e.g., the DAMS) determining whether to continue the inter-network transfer process after obtaining the inter-network transfer transaction. In response to determining to continue the inter-network transfer process, processing logic can cause the source digital wallet to burn the digital asset via the node of the source distributed ledger network. In response to determining to stop the transfer process, processing logic can cause the digital asset to be re-minted onto the source ledger and re-added to the source digital wallet.

For example, determining whether to continue the inter-network transfer process can include performing at least one verification action. The at least one verification action can include verifying that the source digital wallet is valid (e.g., has a valid name and/or a valid address), verifying the authenticity of the inter-network transfer transaction and/or verifying that the digital asset does not currently exist on any other distributed ledger networks.

Verifying the authenticity of the inter-network transfer transaction can include employing a suitable public-key infrastructure (PKI)-based digital signature authentication method. For example, the source digital wallet can sign the inter-network transfer transaction using a private key of the entity, and generate a message including the signed data and the inter-network transfer transaction. The node of the source distributed ledger network, upon receipt of the inter-network transfer transaction, can verify the authenticity of the entity by verifying the signature using a public key of the entity, and verify that the source digital wallet actually possesses the digital asset.

In response to obtaining the notification of the inter-network transfer process, at block 320, processing logic initiates a process to add the digital asset to a target digital wallet. The target digital wallet is a digital wallet of a target distributed ledger network different from the source distributed ledger network. The target distributed ledger network includes a set of nodes managing transactions with respect to a target ledger.

Initiating the process to add the digital asset to the target digital wallet can include causing a node of the target distributed ledger network to mint the digital asset. For example, causing the node of the target distributed ledger network to mint the digital asset can include causing the node of the target distributed ledger network to execute a subset of executable instructions of a set of executable instructions stored on the target ledger. In some implementations, the set of executable instructions stored on the target ledger is comprised within a smart contract.

In some implementations, initiating the process to add the digital asset to the target digital wallet includes determining whether to continue the inter-network transfer process after obtaining the notification of the inter-network transfer process. In response to determining to continue the inter-network transfer process, processing logic can cause the node of the target distributed ledger network to mint the digital asset to the target ledger and add the digital asset to the target digital wallet. In response to determining to stop the inter-network transfer process, processing logic can prevent the digital asset from being minted to the target ledger and added to the target digital wallet. For example, determining whether to continue the inter-network transfer process can include performing at least one verification action. The at least one verification action can include verifying that the target digital wallet is valid (e.g., has a valid name and/or a valid address), verifying the authenticity of the notification of the inter-network transfer process and/or verifying that the digital asset does not currently exist on any other distributed ledger networks. Verifying the authenticity of the notification of the inter-network transfer process can include employing a suitable PKI-based digital signature authentication method.

As a node on a decentralized network, an operator of a DAMS can run its own nodes or uses hosted nodes of a third-party that the DAMS operator trusts. These nodes can incorporate the new blocks that are propagated on the decentralized network by verifying each block including digital signatures of each transaction and tree (e.g., Merkle tree) validity. These transactions generate events that are emitted by the node and can be trusted due to the trusted nature of the node software implementation to execute the correct verifications.

At block 330, processing logic obtains a notification that the digital asset was successfully added to the target digital wallet. For example, the notification that the digital asset was successfully added to the target digital wallet can include a success event notification emitted by the node of the target distributed ledger network, and obtaining the notification that the digital asset was successfully added to the target digital wallet can include observing the transfer event notification. For example, the node of the target distributed ledger network can emit the success event notification in response to verifying the mint transaction and updating the target ledger to reflect the mint transaction.

In response to obtaining the notification that the digital asset was successfully added to the target digital wallet, at block 340, processing logic finalizes the transfer process. Finalizing the transfer process can include setting the address of the target digital wallet as the current location of the digital asset. Finalizing the transfer process can further include updating the digital asset structure to indicate that the digital asset is located on the target ledger. Further details regarding blocks 310-340 are described above with reference to FIGS. 1-2C.

In some implementations, the source digital wallet is a custodied digital wallet under control of an operator of the processing device, the target digital wallet is one of: a private digital wallet under control of an owner of the digital asset, or another custodied digital wallet under control of a third-party proxy, and the inter-network transfer process is a withdrawal process. Further details regarding the withdrawal process will be described below with reference to FIGS. 1 and 2A.

In some implementations, the source digital wallet is a private digital wallet under control of an owner of the digital asset, the target digital wallet is a custodied wallet under control of an operator of the processing device, and the inter-network transfer process is a deposit process. Further details regarding the deposit process are described above with reference to FIGS. 1 and 2B.

In some implementations, the source digital wallet is a first private digital wallet under control of an owner of the digital asset, the target digital wallet is a second private digital wallet under control of a second owner of a second digital asset, and the inter-network transfer process is a pseudo-anonymous swap process. Further details regarding the swap process are described above with reference to FIGS. 1 and 2C.

In some implementations, the inter-network transfer process is initiated by a proxy on behalf of the digital asset owner. The proxy can be any entity given permission to manage the inter-network transfer process on behalf of the entity. For example, the proxy can be listed as an additional owner (e.g., via the set of executable instructions). In some implementations, the proxy is a third-party entity in custody of digital assets (i.e., neither the digital asset owner nor the DAMS).

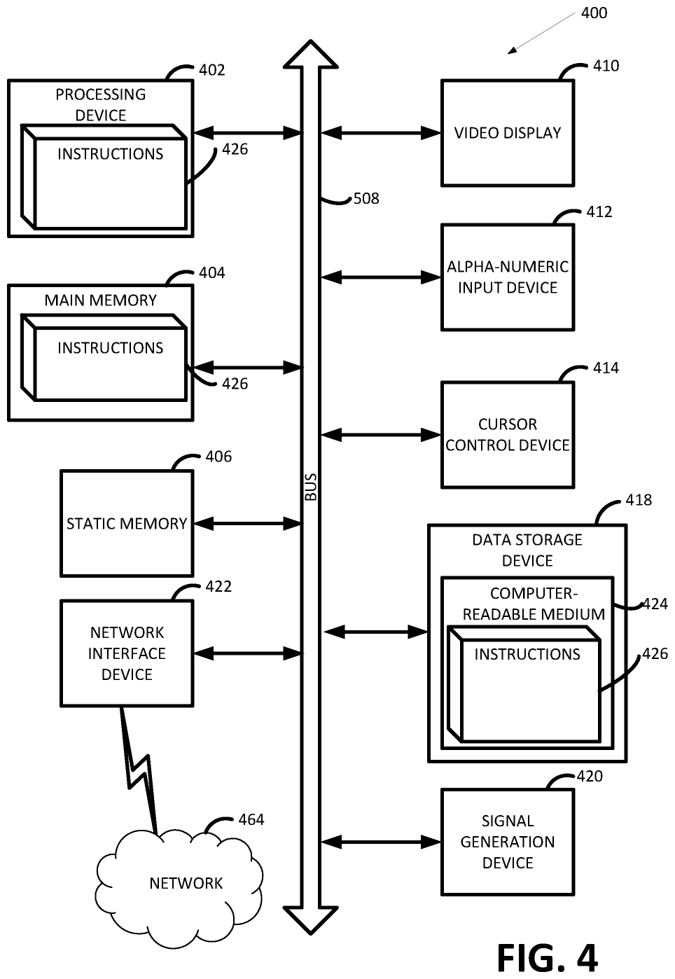

FIG. 4 depicts a block diagram of a computer system 400 operating in accordance with one or more aspects of the disclosure. In various illustrative examples, computer system 400 may correspond to computer system 100 of FIG. 1. The computer system may be included within a data center that supports virtualization. Virtualization within a data center can result in a physical system being virtualized using virtual machines to consolidate the data center infrastructure and increase operational efficiencies. A virtual machine (VM) may be a program-based emulation of computer hardware. For example, the VM may operate based on computer architecture and functions of computer hardware resources associated with hard disks or other such memory. The VM may emulate a physical computing environment, but requests for a hard disk or memory may be managed by a virtualization layer of a computing device to translate these requests to the underlying physical computing hardware resources. This type of virtualization results in multiple VMs sharing physical resources.

In certain implementations, computer system 400 may be connected (e.g., via a network 464, such as a Local Area Network (LAN), an intranet, an extranet, or the Internet) to other computer systems. Computer system 400 may operate in the capacity of a server or a client computer in a client-server environment, or as a peer computer in a peer-to-peer or distributed network environment. Computer system 400 may be provided by a personal computer (PC), a tablet PC, a set-top box (STB), a Personal Digital Assistant (PDA), a cellular telephone, a web appliance, a server, a network router, switch or bridge, or any device capable of executing a set of executable instructions (sequential or otherwise) that specify actions to be taken by that device. Further, the term “computer” shall include any collection of computers that individually or jointly execute a set (or multiple sets) of instructions to perform any one or more of the methods described herein.

In a further aspect, the computer system 400 may include a processing device 402, a volatile memory 404 (e.g., random access memory (RAM)), a non-volatile memory 406 (e.g., read-only memory (ROM) or electrically-erasable programmable ROM (EEPROM)), and a data storage device 416, which may communicate with each other via a bus 408.

Processing device 402 may be provided by one or more processors such as a general purpose processor (such as, for example, a complex instruction set computing (CISC) microprocessor, a reduced instruction set computing (RISC) microprocessor, a very long instruction word (VLIW) microprocessor, a microprocessor implementing other types of instruction sets, or a microprocessor implementing a combination of types of instruction sets) or a specialized processor (such as, for example, an application specific integrated circuit (ASIC), a field programmable gate array (FPGA), a digital signal processor (DSP), or a network processor).

Computer system 400 may further include a network interface device 422. Computer system 400 also may include a video display unit 410 (e.g., an LCD), an alphanumeric input device 412 (e.g., a keyboard), a cursor control device 414 (e.g., a mouse), and a signal generation device 420. Data storage device 416 may include a non-transitory computer-readable storage medium 424 on which may store instructions 426 encoding any one or more of the methods or functions described herein, including instructions for implementing, e.g., DAMS 130. Instructions 426 may also reside, completely or partially, within volatile memory 404 and/or within processing device 402 during execution thereof by computer system 400, hence, volatile memory 404 and processing device 402 may also constitute machine-readable storage media.

While computer-readable storage medium 424 is shown in the illustrative examples as a single medium, the term “computer-readable storage medium” shall include a single medium or multiple media (e.g., a centralized or distributed database, and/or associated caches and servers) that store the one or more sets of executable instructions. The term “computer-readable storage medium” shall also include any tangible medium that is capable of storing or encoding a set of executable instructions for execution by a computer that cause the computer to perform any one or more of the methods described herein. The term “computer-readable storage medium” shall include, but not be limited to, solid-state memories, optical media, and magnetic media.

Other computer system designs and configurations may also be suitable to implement the system and methods described herein. The following examples illustrate various implementations in accordance with one or more aspects of the present disclosure.

Although the operations of the methods herein are shown and described in a particular order, the order of the operations of each method may be altered so that certain operations may be performed in an inverse order or so that certain operations may be performed, at least in part, concurrently with other operations. In certain implementations, instructions or sub-operations of distinct operations may be in an intermittent and/or alternating manner. In certain implementations, not all operations or sub-operations of the methods herein are required to be performed.

It is to be understood that the above description is intended to be illustrative, and not restrictive. Many other implementations will be apparent to those of skill in the art upon reading and understanding the above description. The scope of the disclosure should, therefore, be determined with reference to the appended claims, along with the full scope of equivalents to which such claims are entitled.

In the above description, numerous details are set forth. It will be apparent, however, to one skilled in the art, that aspects of the present disclosure may be practiced without these specific details. In some instances, well-known structures and devices are shown in block diagram form, rather than in detail, in order to avoid obscuring the present disclosure.

Unless specifically stated otherwise, as apparent from the following discussion, it is appreciated that throughout the description, discussions utilizing terms such as “obtaining,” “receiving,” “executing,” “sending,” “initiating,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present disclosure also relates to an apparatus for performing the operations herein. This apparatus may be specially constructed for the specific purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

Aspects of the disclosure presented herein are not inherently related to any particular computer or other apparatus. Various general purpose systems may be used with programs in accordance with the teachings herein, or it may prove convenient to construct more specialized apparatus to perform the specified method steps. The structure for a variety of these systems will appear as set forth in the description below. In addition, aspects of the present disclosure are not described with reference to any particular programming language. It will be appreciated that a variety of programming languages may be used to implement the teachings of the disclosure as described herein.

Aspects of the present disclosure may be provided as a computer program product that may include a machine-readable medium having stored thereon instructions, which may be used to program a computer system (or other electronic devices) to perform a process according to the present disclosure. A machine-readable medium includes any mechanism for storing or transmitting information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices, etc.).

The words “example” or “exemplary” are used herein to mean serving as an example, instance, or illustration. Any aspect or design described herein as “example” or “exemplary” is not to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an embodiment” or “one embodiment” or “an implementation” or “one implementation” throughout is not intended to mean the same embodiment or implementation unless described as such. Furthermore, the terms “first,” “second,” “third,” “fourth,” etc. as used herein are meant as labels to distinguish among different elements and may not have an ordinal meaning according to their numerical designation.

What is claimed is:

1. A method comprising:
obtaining, by a processing device from a first node of a source distributed ledger network maintaining a source ledger, a first notification of an inter-network transfer process with respect to a digital asset, wherein the source ledger stores a first set of executable instructions for controlling the transfer process, and wherein the first notification indicates that the digital asset was removed from a source digital wallet of the source distributed ledger network;
causing, by the processing device, the digital asset to be associated with a target digital wallet of a target distributed ledger network maintaining a target ledger, wherein causing the digital asset to be associated with the target digital wallet comprises causing a second node of the target distributed ledger network to execute a second set of executable instructions for controlling the transfer process, and wherein the second set of executable instructions is stored on the target ledger;
obtaining, by the processing device from the second node of the target distributed ledger network, a second notification of the digital asset being associated with the target digital wallet; and
in response to obtaining the second notification, designating the target distributed ledger network as a distributed ledger network maintaining the digital asset.

2. The method of claim 1, further comprising deploying, by the processing device, the first set of executable instructions to the source ledger and the second set of executable instructions to the target ledger.

3. The method of claim 1, wherein the first set of executable instructions implements a first smart contract for controlling the inter-network transfer process, and wherein the second set of executable instructions implements a second smart contract for controlling the inter-network transfer process.

4. The method of claim 1, wherein the digital asset comprises a non-fungible token (NFT).

5. The method of claim 1, wherein the source digital wallet is a custodied digital wallet under control of an operator of the processing device, wherein the target digital wallet is one of:
a private digital wallet under control of an owner of the digital asset, or another custodied digital wallet under control of a third-party proxy, and wherein the inter-network transfer process is a withdrawal process.

6. The method of claim 1, wherein the source digital wallet is a private digital wallet under control of an owner of the digital asset, wherein the target digital wallet is a custodied wallet under control of an operator of the processing device, and wherein the inter-network transfer process is a deposit process.

7. The method of claim 1, wherein the source digital wallet is a first private digital wallet under control of an owner of the digital asset, wherein the target digital wallet is a second private digital wallet under control of a second owner of a second digital asset, and wherein the inter-network transfer process is a pseudo-anonymous swap process.

8. A system comprising:
a memory; and
a processing device, operatively coupled to the memory, to perform operations comprising:
obtaining, from a first node of a source distributed ledger network maintaining a source ledger, a first notification of an inter-network transfer process with respect to a digital asset, wherein the source ledger stores a first set of executable instructions for controlling the transfer process, and wherein the first notification indicates that the digital asset was removed from a source digital wallet of the source distributed ledger network;
causing the digital asset to be associated with a target digital wallet of a target distributed ledger network maintaining a target ledger, wherein causing the digital asset to be associated with the target digital wallet comprises causing a second node of the target distributed ledger network to execute a second set of executable instructions for controlling the transfer process, and wherein the second set of executable instructions is stored on the target ledger;
obtaining, from the second node of the target distributed ledger network, a second notification of the digital asset being associated with the target digital wallet; and
in response to obtaining the second notification, designating the target distributed ledger network as a distributed ledger network maintaining the digital asset.

9. The system of claim 8, wherein the operations further comprise deploying the first set of executable instructions to the source ledger and the second set of executable instructions to the target ledger.

10. The system of claim 8, wherein the first set of executable instructions implements a first smart contract for controlling the inter-network transfer process, and wherein the second set of executable instructions implements a second smart contract for controlling the inter-network transfer process.

11. The system of claim 8, wherein the digital asset comprises a non-fungible token (NFT).

12. The system of claim 8, wherein the source digital wallet is a custodied digital wallet under control of an operator of the processing device, wherein the target digital wallet is one of:
a private digital wallet under control of an owner of the digital asset, or another custodied digital wallet under control of a third-party proxy, and wherein the inter-network transfer process is a withdrawal process.

13. The system of claim 8, wherein the source digital wallet is a private digital wallet under control of an owner of the digital asset, wherein the target digital wallet is a custodied wallet under control of an operator of the processing device, and wherein the inter-network transfer process is a deposit process.

14. The system of claim 8, wherein the source digital wallet is a first private digital wallet under control of an owner of the digital asset, wherein the target digital wallet is a second private digital wallet under control of a second owner of a second digital asset, and wherein the inter-network transfer process is a pseudo-anonymous swap process.

15. A system comprising:
a source digital wallet associated with a source distributed ledger network, the source distributed ledger network comprising a first node maintaining a source ledger, wherein the source ledger comprises a first set of executable instructions for controlling an inter-network transfer process;
a target digital wallet associated with a target distributed ledger network different from the source distributed ledger network, the target distributed ledger network comprising a second node maintain a target ledger, wherein the target ledger comprises a second set of executable instructions for controlling the inter-network transfer process; and
a digital asset management system, the digital asset management system comprising:
a memory; and
a processing device, operatively coupled to the memory, to perform operations comprising:
obtaining, from the first node, a first notification of the inter-network transfer process with respect to a digital asset, wherein the first notification indicates that the digital asset was removed from the source digital wallet;
in response to obtaining the first notification, causing the digital asset to be associated with the target wallet by causing the second node to execute the second set of executable instructions;
obtaining, from the second node, a second notification of the digital asset being added to the second digital wallet; and
in response to receiving the second notification, designating the target distributed ledger network as a distributed ledger network maintaining the digital asset.

16. The system of claim 15, wherein the operations further comprise deploying the first set of executable instructions to the source ledger and the second set of executable instructions to the target ledger.

17. The system of claim 15, wherein the first set of executable instructions is comprised within a first smart contract for controlling the inter-network transfer process, and wherein the second set of executable instructions is comprised within a second smart contract for controlling the inter-network transfer process.

18. The system of claim 15, wherein the source digital wallet is a custodied digital wallet under control of an operator of the processing device, wherein the target digital wallet is one of:
a private digital wallet under control of an owner of the digital asset, or another custodied digital wallet under control of a third-party proxy, and wherein the inter-network transfer process is a withdrawal process.

19. The system of claim 15, wherein the source digital wallet is a private digital wallet under control of an owner of the digital asset, wherein the target digital wallet is a custodied wallet under control of an operator of the processing device, and wherein the inter-network transfer process is a deposit process.

20. The system of claim 15, wherein the source digital wallet is a first private digital wallet under control of an owner of the digital asset, wherein the target digital wallet is a second private digital wallet under control of a second owner of a second digital asset, and wherein the inter-network transfer process is a pseudo-anonymous swap process.
